(19) United States
(12) Patent Application Publication
(10) Pub. No.: US 2011/0146966 A1
(43) Pub. Date: Jun. 23, 2011

(54) Cooling Device

(75) Inventor: Ernst Scherrer, Greifensee (CH)

(73) Assignee: Micronel AG, Tagelswangen (CH)

(21) Appl. No.: 12/970,335

(22) Filed: Dec. 16, 2010

(30) Foreign Application Priority Data
Dec. 23, 2009 (EP) 09 405 231.3

(51) Int. Cl. G05D 23/01; F28F 13/00

(52) U.S. Cl. 165/287; 165/121

(57) ABSTRACT

The cooling device has a fan having a fan wheel, and a heat sink, through which there is a flow for cooling purposes when the fan wheel rotates. The heat sink has guide vanes deviating from the radial direction and is embodied as an integral shaped part. In particular, the guide vanes are embodied in spiral fashion. The cooling device serves, in particular, for cooling an LED lamp.

### BACKGROUND OF THE INVENTION

1. Field of the Invention

The invention relates to a cooling device, in particular a cooling device for an LED lamp, comprising a fan having a fan wheel, and comprising a heat sink, through which air flows for cooling purposes when the fan wheel rotates.

2. Description of the Related Art

Compared with conventional incandescent lamps, LED lamps have a significantly longer lifetime and a likewise significantly lower energy consumption. Compared with energy-saving lamps, the average lifetime in the case of LED lamps is significantly longer given approximately the same energy consumption, and so the usually higher production costs in the case of LED lamps are justified. In the case of LED lamps there is the difficulty that it is necessary to cool the LED elements with high power. To dissipate the heat, heat sinks are generally used which effect passive or active cooling. In order to achieve the required cooling effect in conjunction with a compact design, there are already numerous proposals in the prior art.

U.S. 2005/0174780 discloses an LED lamp having a heat sink, which can be cooled by a fan built into the latter. The heat sink has radially extending walls between which the air generated by the fan can flow through in order to dissipate the heat generated by LED components.

U.S. 2006/0193139 discloses an LED lamp likewise having a heat sink and a fan. The fan draws in air radially and emits it axially to the heat sink.

EP 1 998 108 discloses an LED lamp having a substantially tubular housing, in which a fan and a heat sink are arranged. When the fan is running, an air flow is generated in the housing, said air flow in turn generating a further air flow, which flows through side openings.

WO 2008/103676 discloses an LED lamp having an oscillating plate for generating an air flow.

U.S. 2008/0212332 discloses an LED lamp which is cooled with a liquid, and in particular water.

The invention is based on the object of providing a cooling device of the above-mentioned type which is suitable, in particular, for cooling an LED lamp and which can be embodied even more compactly with the same or higher power.

The object is achieved in the case of a cooling device of the generic type by virtue of the fact that the heat sink has guide vanes deviating from the radial direction and is embodied as an integral shaped part. The guide vanes deviating from the radial direction enable an optimum air deflection and a largest possible surface contact for the heat sink. The embodiment of the guide vanes substantially has the advantage that direct access to the edge of the fan is prevented.

A particularly compact design arises when, in accordance with one development of the invention, the fan is integrated into the heat sink.

A particularly effective cooling effect and large surface contact arise when, in accordance with one development of the invention, the guide vanes are embodied in spiral fashion.

One development of the invention provides for the guide vanes to be integrally formed on a plate having an outer side, on which the components to be cooled can be fixed. The guide vanes can extend in one axial direction or else in both axial directions of said plate. The plate is preferably planar, for example square or round.

One development of the invention provides for the heat sink to be embodied substantially in pear-shaped fashion. Such a heat sink is suitable, in particular, for an LED lamp.

One development of the invention provides for the fan to have a motor circuit board, and for the heat sink to have a support for the bearing accommodation and the fixing of the motor circuit board. This likewise enables a very compact design and cost-effective production.

The invention additionally relates to a lamp comprising a cooling device according to the invention. In this case, the cooling device forms a built-in unit composed of the heat sink and the fan. The lamp is, in particular, an LED lamp, wherein the LED elements are fixed directly on the heat sink. The use of the cooling device for a lamp is the preferred application. In principle, the cooling device according to the invention could also be used for cooling other components, in particular electronic components.

### BRIEF DESCRIPTION OF THE DRAWINGS

Further advantageous features emerge from the dependent patent claims, the description below, and also the drawings.

Exemplary embodiments of the invention are explained in greater detail below with reference to the drawings, in which:

FIG. 1 shows an axial section through a cooling device according to the invention.

FIG. 2 shows a three-dimensional view of the cooling device in accordance with FIG. 1.

FIG. 3 shows a further three-dimensional view of the cooling device in accordance with FIG. 1.

FIGS. 4-7 each show a three-dimensional view of a variant of the cooling device according to the invention.

FIG. 8 shows a lamp according to the invention partly in sectional view.

### DETAILED DESCRIPTION OF THE INVENTION

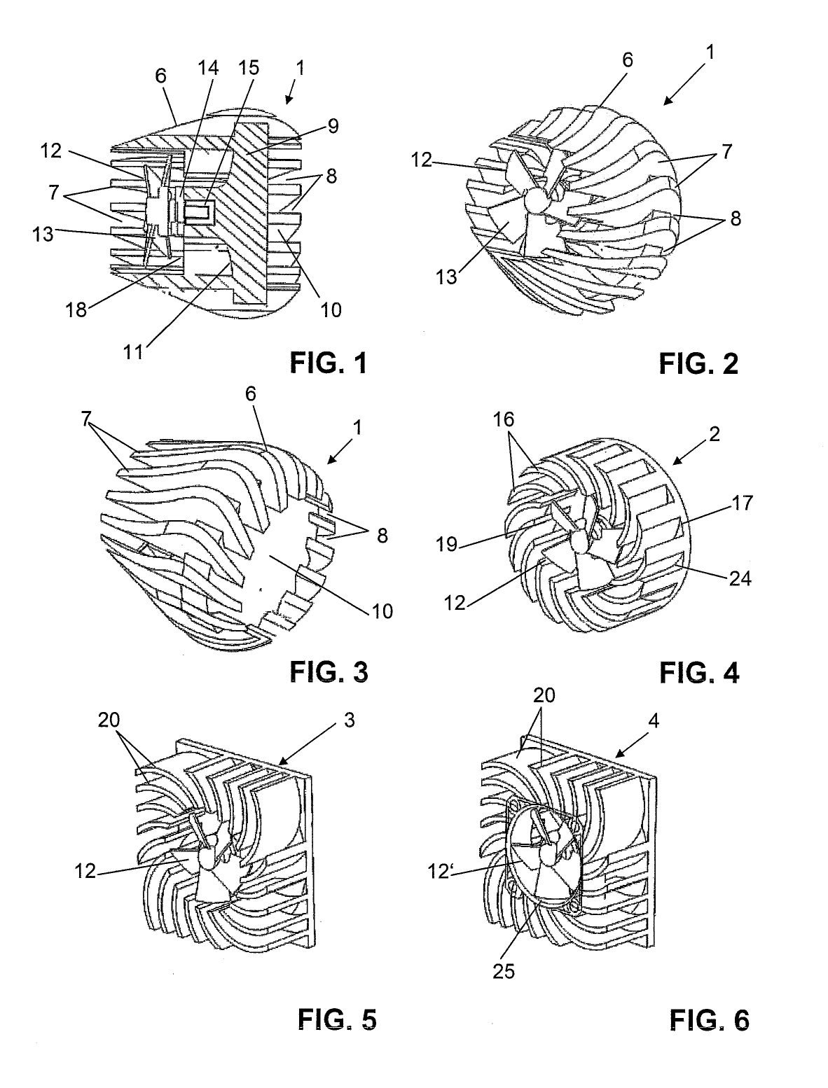

FIGS. 1 to 3 show a cooling device 1 having a heat sink 6, which has a plate 9, on which guide vanes embodied in spiral fashion are integrally formed. The plate 9 has a surface 10 extending vertically with respect to the longitudinal direction of the heat sink 1, onto which surface components, for example LED components, can be fixed. A bearing 15 is arranged at a rear-side surface 11 of the plate 9, a fan 12 being mounted in said bearing. The fan 12 is situated in a cutout 14 of the heat sink 6.

Air channels 8 extending axially and outwards are arranged between the guide vanes 7. As can be seen, said air channels 8 extend axially beyond the surfaces 10 and 11. An air flow generated by the fan 12 is diverted in a radial direction by the guide vanes 7. An outflow of the air already takes place at the level of a fan wheel 13 of the fan 12. As a result, the plate 9 is cooled by the guide vanes 17 surrounding it with high power. The heat sink 6 is therefore actively cooled by air flowing through. The heat sink 6 together with the fan 12 forms one unit, which, by way of example, in accordance with FIG. 8 can be built into a lamp 23, in particular an LED lamp. The fan 12 has a motor circuit board 14, on which the fan wheel 13 is mounted. Such motor circuit boards 14 are known per se. The fan 12 is preferably inserted without a housing into the cutout 18. The fan wheel 13 is an axial impeller. However, the air flow generated is not exclusively axial, but partly also radial. As can be seen, the outer form of the heat sink 6 is approximately pear-shaped. This form is suitable, in particular, for the application of the heat sink 6 for cooling the lamp 22 shown in FIG. 8.

FIG. 4 shows a cooling device 2 having guide vanes 16, which extend outwards in a radial direction in a curved fashion and which are integrally formed on a planar plate 17. The fan 12 is arranged in a cutout 19, said fan in this case likewise having an axial fan wheel 13. A radial air flow generated by the fan wheel 12 is therefore deflected in a curved fashion by the curved guide vanes 16. This results, in this case, too, in a large cooling surface at the guide vanes 16. The outflowing air likewise directly cools the plate 17 and surfaces 24 extending in each case between two adjacent guide vanes 16. The cooling device 2 likewise forms one unit that can be built into a device, for example an LED lamp.

The cooling device 3 shown in FIG. 5 differs from that in accordance with FIG. 4 by virtue of the rectangular, and in particular square, embodiment. The guide vanes 20 provided here are likewise curved in a radial direction.

The cooling device 4 shown in FIG. 6 largely corresponds to the cooling device 3 in accordance with FIG. 5, in this case a standard fan 12′ that has a housing 25 being built in.

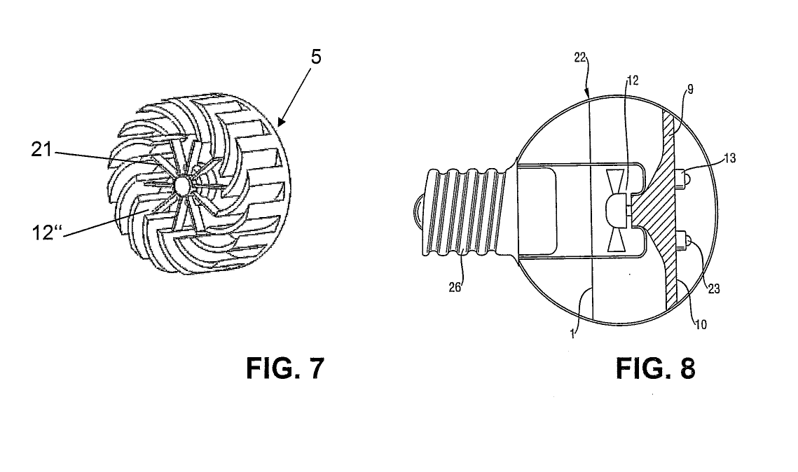

The cooling device 5 shown in FIG. 7 largely corresponds to the cooling device 2 in accordance with FIG. 4, but in this case a fan 12′ that is a radial fan is provided. Accordingly, a fan wheel 21 that primarily generates a radial air flow is provided.

The lamp 22 shown in FIG. 8 has, for example, a customary mount 26, and also a built-in cooling device 1. A plurality of LED elements 23 are arranged on the surface 10 of the cooling device 1. Said elements 23 can be connected directly or else indirectly to the plate 9, which is actively cooled by the fan 12 as explained above. The heat generated by the LED elements 23 is therefore dissipated via the plate 9 of the cooling device.

List of Reference Symbols

| | |
|---|---|
| 1. Cooling device | 2. Cooling device |
| 3. Cooling device | 4. Cooling device |
| 5. Cooling device | 6. Heat sink |
| 7. Guide vanes | 8. Air channels |
| 9. Plate | 10. Surface |
| 11. Surface | 12. Fan |
| 13. Fan wheel | 14. Motor circuit board |
| 15. Bearing | 16. Guide vanes |
| 17. Plate | 18. Cutout |
| 19. Cutout | 20. Guide vanes |
| 21. Fan wheel | 22. Lamp |
| 23. LED element | 24. Surface |
| 25. Housing | 26. Mount |

1-9. (canceled)

10. A cooling device for a lamp comprising a fan having a fan wheel and a heat sink through which there is a flow for cooling purposes when the fan wheel rotates, wherein the heat sink has guide vanes deviating from the radial direction and is embodied as an integral shaped part.

11. The cooling device according to claim 10, wherein the fan is integrated in the heat sink.

12. The cooling device according to claim 10, wherein the guide vanes are embodied in spiral fashion.

13. The cooling device according to claim 10, wherein the guide vanes are integrally formed on a plate having an outer side, on which the components to be cooled can be fixed.

14. The cooling device according to claim 10, wherein the heat sink is embodied substantially in pear-shaped fashion.

15. The cooling device according to claim 10, wherein the fan is regulated by means of a temperature sensor for noise reduction.

16. The cooling device according to claim 11, wherein the fan has a motor circuit board, and in that the heat sink has a support for the bearing accommodation and the fixing of the motor circuit board.

17. A cooling device for an LED lamp comprising a fan having a fan wheel and a heat sink through which there is a flow for cooling purposes when the fan wheel rotates, wherein the heat sink has guide vanes deviating from the radial direction and is embodied as an integral shaped part.

18. The lamp comprising a cooling device according to claim 17, wherein the cooling device forms a built-in unit composed of the heat sink and the fan.

19. The lamp according to claim 17, wherein the lamp is an LED lamp having LED elements fixed directly on the heat sink.
